(19) United States
(12) Patent Application Publication
(10) Pub. No.: US 2013/0136974 A1
(43) Pub. Date: May 30, 2013

(54) SAFETY STRUCTURE FOR HIGH VOLTAGE BATTERY OF VEHICLE

(71) Applicants: Do Kyoung Lim, Hwaseong (KR); Suk Hyung Kim, Hwaseong (KR); Jae Hoon Choi, Gunpo (KR); Yoon Jun Lee, Hwaseong (KR)

(72) Inventors: Do Kyoung Lim, Hwaseong (KR); Suk Hyung Kim, Hwaseong (KR); Jae Hoon Choi, Gunpo (KR); Yoon Jun Lee, Hwaseong (KR)

(73) Assignees: KIA MOTORS CORPORATION, Seoul (KR); HYUNDAI MOTOR COMPANY, Seoul (KR)

(21) Appl. No.: 13/530,477

(22) Filed: Jun. 22, 2012

(30) Foreign Application Priority Data
Nov. 30, 2011 (KR) 10-2011-0126461

(51) Int. Cl. H01M 2/30

(52) U.S. Cl. 429/157

(57) ABSTRACT

Disclosed is a safety structure for a high voltage battery of a vehicle. The safety structure includes a plurality of battery modules arranged in series with opposing poles adjacent to each other and a plurality of bus bars electrically connecting terminals having opposing poles of neighboring battery modules among the battery modules with each other. Furthermore, a meltable section having a locally large electrical resistance value is integrally formed in each bus bar itself.

### CROSS-REFERENCE TO RELATED APPLICATION

This application claims under 35 U.S.C. §119(a) the benefit of Korean Patent Application No. 10-2011-0126461 filed on Nov. 30, 2011, the entire contents of which are incorporated herein by reference.

### BACKGROUND

(a) Technical Field

The present invention relates to a safety structure of a high voltage battery of a vehicle, and more particularly, to a technology configured to ensure safety of the vehicle against high current is generated by the high voltage battery due to an internal short-circuit or damage to the vehicle.

(b) Background Art

High voltage batteries are typically mounted on vehicles that use electricity as at least one of the main driving forces of the vehicle, such as hybrid vehicles, plug-in hybrid vehicles, electric vehicles, etc. A plurality of battery cells in these high voltage batteries are typically connected in series together to create a battery module and a plurality of battery modules are typically connected together to create one battery pack, and as a result, the high voltage batteries are generally mounted as a single battery pack rather than as individual components.

Since high voltage batteries store very high amount of energy therein, a significantly large current flows therethrough instantaneously when a vehicle accident or an internal short-circuit of the high voltage battery occurs, and as a result, various dangerous situations such as an electric shock or fire may occur. Therefore, countermeasures capable of preparing for these types of situations are required.

In the conventional art, as one of the countermeasures for preparing for the dangerous situations, a safety plug shown in FIG. 1 is adopted. In this configuration a high voltage is generated by connecting a plurality of battery modules 500 including a plurality of battery cells therein with bus bars 502 in series. When an abnormal current flow situation occurs in the battery pack 506, safety plugs 504, serving as fuses, interrupt the current flow in the circuit.

However, this countermeasure is only function for large scale battery packs 506 like the one shown in FIG. 1. This countermeasure is not an appropriate countermeasure against a short-circuit or high current flow that occurs in an individual battery module 500 or among a few the battery modules 500. Thus, a device which can prevent a short circuit in the individual battery modules 500 as well is also needed.

Matters described as the background art are just to improve the background of the present invention, but it should not be understood that the matters correspond to the related art which has been already known to those skilled in the art.

### SUMMARY OF THE DISCLOSURE

The present invention has been made in an effort to provide a safety structure of a high voltage battery of a vehicle configured to further improve safety of the high voltage battery by interrupting high current flow when high current is generated in a portion of the battery that a safety plug cannot interrupt due to an internal short-circuit of each of battery modules making up the high voltage battery or damage to the vehicle.

An exemplary embodiment of the present invention provides a safety structure of a high voltage battery of a vehicle, including: a plurality of battery modules arranged in series with opposing poles adjacent to each other; and a plurality of bus bars installed to electrically connect terminals having opposing poles of neighboring battery modules among the battery modules with each other, and a meltable section having a locally large electrical resistance value integrally formed in the bus bar itself.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing a safety structure of a high voltage battery of a vehicle in the conventional art;

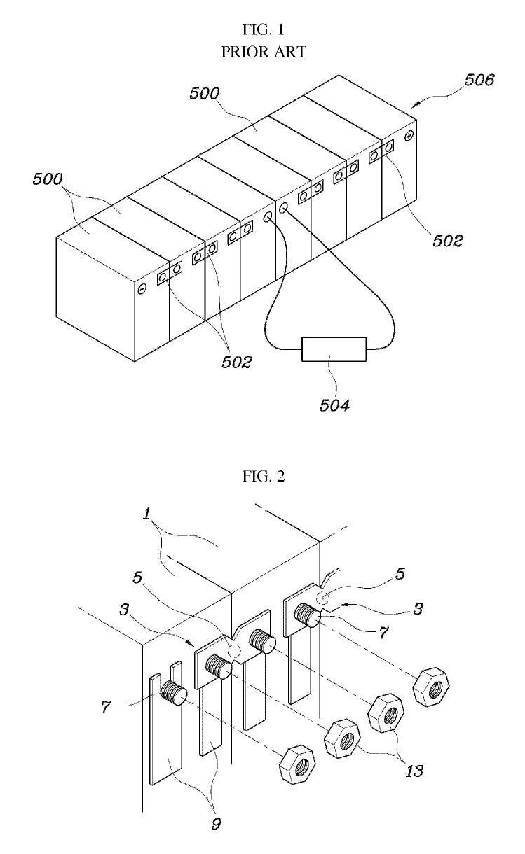

FIG. 2 is a diagram showing a safety structure of a high voltage battery of a vehicle according to an exemplary embodiment of the present invention; and

FIGS. 3 to 6 are diagrams showing examples of bus bars used in the safety structure of the high voltage battery of the vehicle according to the exemplary embodiment of the present invention.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

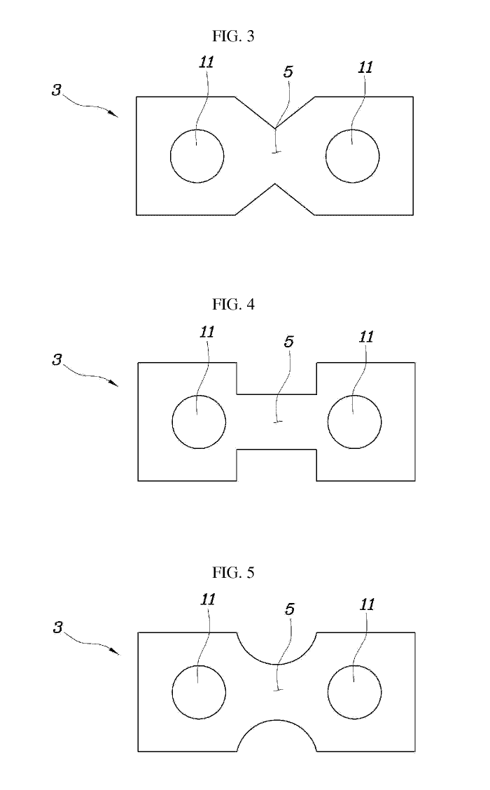

Referring to FIG. 2, a safety structure of a high voltage battery of a vehicle according to an exemplary embodiment of the present invention includes a plurality of battery modules 1 arranged in series with different/opposing poles adjacent to each other; and a plurality of bus bars 3 installed to electrically connect terminals having different/opposing poles of neighboring battery modules 1 among the battery modules 1 with each other and a meltable section 5 having a locally large electrical resistance value integrally formed in the bus bar 3 itself.

That is, the meltable section 5 having the locally large electrical resistance value is integrally provided in the bus bar 3 itself which connects the battery modules 1 electrically together, and as a result, when current above a predetermined value flows among the battery modules 1 due to an internal short-circuit of the battery module 1 or damage of the vehicle, the meltable section 5 having the electrical resistance value relatively larger than the vicinity thereof is melted while emitting heat to short-circuit or interrupt the flow of the high current. Accordingly, when the safety structure of the high voltage battery is adopted, a safety countermeasure against high current in each battery module unit is devised, thereby further improving the safety of vehicles mounted with these types of high voltage batteries.

In the exemplary embodiment, the meltable section 5 of the bus bar 3 is formed in a shape in which a cross section decreases through which current can pass between both parts of the bus bar 3 coupled to the terminals of the battery module 1. That is, since resistance of a wire through which the current passes is in inverse portion to the cross section, the electrical resistance is largely increased by locally reducing the cross section of the bus bar 3, and as a result, a part where the cross section is reduced serves as the meltable section 5. In the meltable section 5, a part of the bus bar 3 may be made of a metallic material which can be melted relatively easily by the electrical resistance.

In the battery module 1, a terminal boss 7, which protrudes to penetrate the bus bar 3 and is made of a material having a predetermined level of conductivity, integrally protrudes on the surface coupled with the bus bar 3. Furthermore, a plate-shaped terminal plate 9 surrounding the vicinity of the terminal boss 7 while being electrically connected with the battery cells in the battery module 1 is provided as well and a terminal coupling hole 11 through which the terminal boss 7 passes is formed in the bus bar 3. Therefore, the bus bar 3 is overlapped and coupled with the terminal plate 9 and with the terminal boss 7 inserted into the terminal coupling hole 11, and the coupling state may be securely fixed with a fastening nut 13.

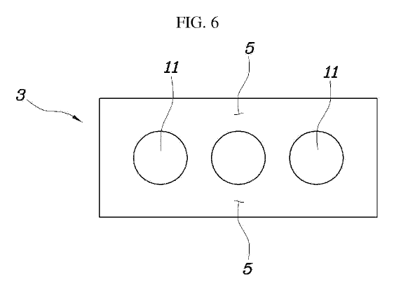

Additionally, the bus bar 3 has an elongated rectangular shape connecting terminals of two neighboring battery modules 1 and the meltable section 5 of the bus bar 3 is formed between both terminal coupling holes 11 of the bus bar 3. The shape of the meltable section 5 may be variously selected, but the meltable section 5 may have a simple shape as shown in FIGS. 3 and 4.

In FIG. 3, the meltable section 5 of the bus bar 3 is formed in a shape in which two triangular sections are cut into the middle of the rectangle depressed on both sides. Meanwhile, in FIG. 4, the meltable section 5 of the bus bar 3 has a shape in which the rectangular section is cut out of the top and bottom of the middle section of the rectangle depressed on both sides and in FIG. 5, the meltable section 5 of the bus bar 3 has a shape in which a semicircular shape is cut into both the top and bottom of the middle of the rectangle depressed on both sides. Further, in the bus bar 3 shown in FIG. 6, the meltable section 5 has a shape in which circular shapes are bored into the center of the rectangle.

All the examples of FIGS. 3 to 6 have a structure in which the cross section is reduced so that the electrical resistance increases locally in the bus bar 3. Thus, the meltable section 5 may be configured in various other shapes. For reference, even when the bus bar 3 is applied between the battery modules 1, the safety of the high voltage battery can be further improved by using the safety plug in the related art together with the illustrative embodiment of the present invention.

According to the exemplary embodiment of the present invention, the safety of the high voltage battery can be further improved by interrupting high current flow when high current flow is generated in a part, which the safety plug cannot interrupt due to the internal short-circuit of each of the battery modules constituting the high voltage battery or the damage of the vehicle.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. A safety structure of a high voltage battery of a vehicle, comprising:
a plurality of battery modules arranged in series with opposing poles adjacent to each other; and
a plurality of bus bars installed to electrically connect terminals having opposing poles of neighboring battery modules among the battery modules with each other,
wherein a meltable section having a locally large electrical resistance value is integrally formed in each bus bar itself.

2. The safety structure of a high voltage battery of a vehicle of claim 1, wherein the meltable section of the bus bar is formed in a shape in which a cross section decreases through which current passes between both parts of the bus bar coupled to the terminals of the battery module.

3. The safety structure of a high voltage battery of a vehicle of claim 2, wherein:
in the battery module, a terminal boss, which protrudes to penetrate the bus bar and is made of a material having certain level of conductivity, integrally protrudes on the surface coupled with the bus bar and a plate-shaped terminal plate surrounding the vicinity of the terminal boss while being electrically connected with the battery cells in the battery,
a terminal coupling hole through which the terminal boss passes is formed in the bus bar, and
the bus bar is overlapped and couples the terminal plate with the terminal boss inserted into the terminal coupling hole.

4. The safety structure of a high voltage battery of a vehicle of claim 3, wherein the meltable section of the bus bar is formed between both terminal coupling holes of the bus bar.

5. The safety structure of a high voltage battery of a vehicle of claim 1, wherein:
the bus bar has an elongated rectangular shape connecting terminals of two neighboring battery modules, and
the meltable section 5 is formed in a shape in which a triangular section is cut out of top and bottom portions of a middle section of the rectangle depressed on both sides.

6. The safety structure of a high voltage battery of a vehicle of claim 1, wherein:
the bus bar has an elongated rectangular shape connecting terminals of two neighboring battery modules, and
the meltable section has a shape in which a rectangular section is cut out of top and bottom portions of a middle section of the rectangle depressed on both sides.

7. The safety structure of a high voltage battery of a vehicle of claim 1, wherein:
the bus bar has an elongated rectangular shape connecting terminals of two neighboring battery modules, and
the meltable section 5 has a shape in which a circular section is cut out of top and bottom portions of a middle section of the rectangle depressed on both sides.

8. The safety structure of a high voltage battery of a vehicle of claim 1 wherein:
the bus bar has an elongated rectangular shape connecting terminals of two neighboring battery modules, and
the meltable section has a shape in which circles are bored within the center of the rectangle.
